(19) United States
(12) Patent Application Publication
(10) Pub. No.: US 2011/0042120 A1
(43) Pub. Date: Feb. 24, 2011

(54) WIRING AND COMPOSITE WIRING

(75) Inventors: Kanji Otsuka, Tokyo (JP); Tamotsu Usami, Tokyo (JP); Chihiro Ueda, Tokyo (JP); Yutaka Akiyama, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignees: IBIDEN CO., LTD., OGAKI-SHI (JP); NEC CORPORATION, TOKYO (JP); FUJITSU SEMICONDUCTOR LIMITED, YOKOHAMA-SHI (JP); FUJI XEROX CO., LTD., TOKYO (JP); KYOCERA CORPORATION, KYOTO-SHI (JP)

(21) Appl. No.: 12/865,555

(22) PCT Filed: Feb. 2, 2009
(86) PCT No.: PCT/JP2009/051729

§ 371 Date: Nov. 10, 2010

(30) Foreign Application Priority Data
Jan. 31, 2008 (JP) 2008-020869

(51) Int. Cl. H01B 11/02

(52) U.S. Cl. 174/113 R

(57) ABSTRACT

A wire (a twisted pair cable) that transmits a gigahertz band signal and that is provided with a pair of core wires that are twisted with each other, a first insulation coating material, a second insulation coating material, and a shield material that shields evanescent waves emitted from the pair of core wires. The pair of core wires have a twisting pitch, a diameter, and a spacing so that the wire has a characteristic impedance of 100 to 200Ω and the phases of the TEM (Transverse Electro-Magnetic) wave and the evanescent wave that are emitted from the pair of core wires are matched.

### TECHNICAL FIELD

The present invention relates to a wire that is preferable for transmitting a gigahertz band high frequency signal, and a composite wire.

### BACKGROUND ART

Recently, a coaxial line, a twisted pair line and the like have become known as a transmission line of a TEM (Transverse Electro-Magnetic) wave. However, because DC resistance (R₀) and dielectric loss (G₀) exist in the transmission line, the signal attenuates during transmission. Especially in the case of transmitting a gigahertz band high frequency signal, because the characteristic impedance (Z₀) in which the DC resistance (R₀) and the dielectric loss (G₀) are combined has a frequency characteristic, the signal attenuates greatly. Furthermore, when an electromagnetic wave transmission state is examined carefully in the transmission line of the high frequency signal, sidelobe-like electromagnetic emission is seen as an evanescent wave. Therefore, attenuation of the signal due to this evanescent wave becomes the same level as the attenuation due to the DC resistance (R₀) and the dielectric loss (G₀) in a transmission line of 100 m or more. Furthermore, in the case of transmitting a signal with this transmission line, crosstalk exists of which electromagnetic waves from outside the transmission line are mixed into the signal transmission line.

Patent Literature 1 discloses a technique to avoid the crosstalk by modifying the structure of a transistor provided in a memory circuit that is connected to the transmission line. Further, Patent Literature 2 discloses a technique to prevent the attenuation of a signal due to the evanescent wave by shielding the transmission line.

Patent Literature 1: Unexamined Japanese Patent Application KOKAI Publication No. 2003-224462

Patent Literature 2: Unexamined Japanese Patent Application KOKAI Publication No. 2005-244733

### DISCLOSURE OF INVENTION

### Problems to be Solved by the Invention

Because the transmission times of the two waves of the TEM wave and the evanescent wave deviates from each other with the configurations disclosed in Patent Literature 1 and Patent Literature 2, there is a fear that the resolution of the signal deteriorates. Therefore, a wire has been desired that is preferable for transmitting a gigahertz band high frequency signal.

The present invention is carried out in view of the above-described problem, and the objective is to provide a wire that is preferable for transmitting a gigahertz band high frequency signal, and a composite wire.

### Means to Solve the Problem

In order to achieve the above-described objective, a wire according to a first viewpoint of the present invention is a wire that transmits a gigahertz band signal and that is provided with a pair of core wires that are twisted with each other, a pair of first insulation coating materials that coat each of the core wires, a second insulation coating material that coats the pair of insulation coating materials, and a shield material that coats the second insulation coating material and that shields evanescent waves emitted from the pair of core wires, and in which the pair of core wires have a twisting pitch, a diameter, and a spacing so that the wire has a characteristic impedance of 100Ω to 200Ω and the phases of the TEM (Transverse Electro-Magnetic) wave and the evanescent wave that are emitted from the pair of core wires are matched.

The twisting pitch of the core wires can be set so that the effective length of the TEM wave becomes the square root of twice a line length of the pair of core wires.

The twisting pitch of the core wires can be 10.3 mm.

The diameter of the core wires can be 0.3 mm.

The spacing of the core wires can be 1.36 mm.

A shock absorbing material can be provided on the outside of the shield material to relieve shock from an external force.

In order to achieve the above-described objectives, a composite wire according to a second aspect of the present invention is provided with a plurality of the above-described wires.

### EFFECT OF THE INVENTION

According to the present invention, a gigahertz band high frequency signal can be suitably transmitted.

### BRIEF DESCRIPTION OF DRAWINGS

FIG. 1 (a) is a schematic drawing showing only a pair of core wires in a twisted pair cable according to the embodiment of the present invention. (b) is a cross-section drawing of the twisted pair cable.

FIG. 2 (a) is a drawing explaining a generation of a TEM wave and an evanescent wave. (b) is a lateral view of (a).

FIG. 3 (a) is a drawing explaining the transmission process of a TEM wave and an evanescent wave in a conventional cable. (b) is a drawing explaining the transmission process of a TEM wave and an evanescent wave in the twisted pair cable according to the present embodiment.

FIG. 4 (a) is a drawing explaining the relationship between an input waveform and a reception waveform in a conventional cable. (b) is a drawing explaining the relationship between an input waveform and a reception waveform in the twisted pair cable according to the present embodiment.

### EXPLANATION OF REFERENCE NUMERALS

10: Twisted pair cable
11: Core wires
12: First coating material
13: Second coating material
14: Shield material
15: Exterior material

### BEST MODE FOR CARRYING OUT THE INVENTION

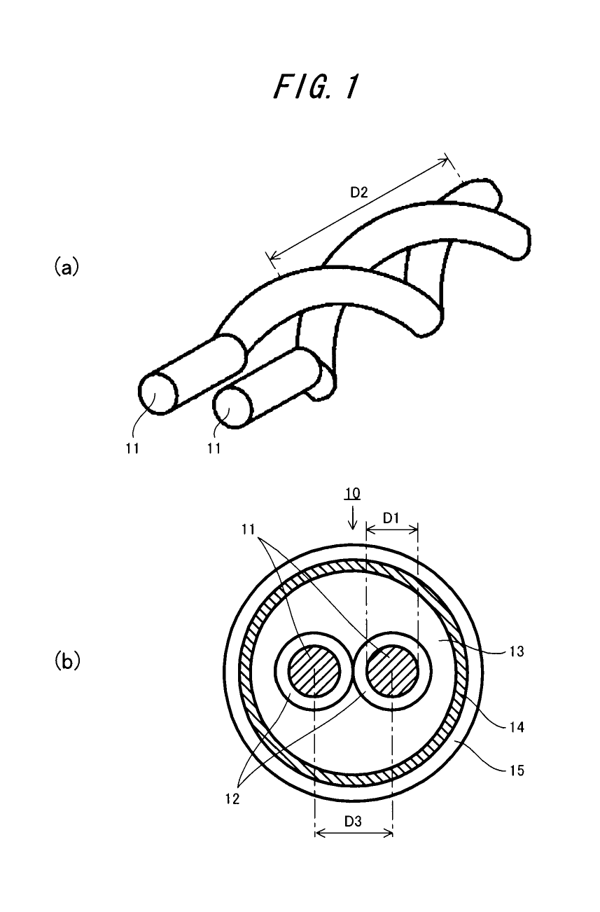

A wire (twisted pair cable) 10 according to the embodiment of the present invention is explained with reference to FIG. 1.

As shown in FIGS. 1 (a) and (b), the twisted pair cable 10 according to the present embodiment is configured with a core wire 11, a first coating material 12, a second coating material 13, a shield material 14, and an exterior material 15. The twisted pair cable 10 is formed so that the characteristic impedance becomes about 135 Ωor more, and preferably 200 Ω.

The core wire 11 is constituted with an electrically conductive material such as copper, and it is formed in a twisted shape by twisting two wires. The diameter D1 of the core wire 11 is about 0.2 mm to 0.4 mm, and preferably 0.3 mm. The pitch D2 of the core wire 11 is about 9 mm to 11 mm, and preferably 10.3 mm. The spacing D3 of two core wires 11 is about 1.2 mm to 1.4 mm, and preferably 1.36 mm. Moreover, in the case that the length of the twisted pair cable 10 is on the order of 100 m, the pitch D2 of the core wire 11 is preferably made to be 10.3 mm±0.4 mm. In addition, in the case that the length of the twisted pair cable 10 is 200 m or more, it is preferably made to be 10.3 mm±0.2 mm.

The first coating material 12 is constituted with an insulation material such as polyvinyl chloride, a fluorocarbon resin, and Teflon (trade mark), and it is formed so that it covers each of two core wires 11 and separates each of two core wires 11. It is preferable that the dielectric constant of the first coating material 12 is 3 or less, and that a material has low transmission loss that is caused by the dielectric. By changing the thickness of the first coating material 12 and widening the spacing D3 of the core wires 11, the characteristic impedance of the twisted pair cable 10 can be made to be higher.

The second coating material 13 is constituted with an insulation material the same as the first coating material 12 is, and it is formed so that it covers the first coating material 12 covering the core wires 11. With the insulation performed by the second coating material 13, the twisted pair cable 10 can maintain a TEM mode transmission that is described later. Furthermore, by adjusting the spacing D3 of the core wires only with the second coating material 13 without forming the first coating material 12, the characteristic impedance can also be made to be high. Moreover, the second coating material 13 and the first coating material 12 use the same insulation material; however, they can use a different insulation material.

The shield material 14 is constituted from a metal material that shields electromagnetic waves such as copper, and is formed so that it covers the second coating material 13. By shielding the evanescent waves emitted into the air from the core wires 11, the shield material 14 shields the energy of the evanescent waves within the shield material 14 and decreases the transmission loss. The thickness of the shield material 14 is arbitrary as long as it can shield the evanescent waves.

The exterior material 15 is constituted from an insulation material having flexibility such as rubber and glass fiber, and is formed to cover and protect the shield material 14, etc. The thickness of the exterior material 15 is arbitrary. Moreover, the exterior material 15 can have a shape that seals the shield material 14, etc. in order to prevent water, oil, etc. from entering into the exterior material 15.

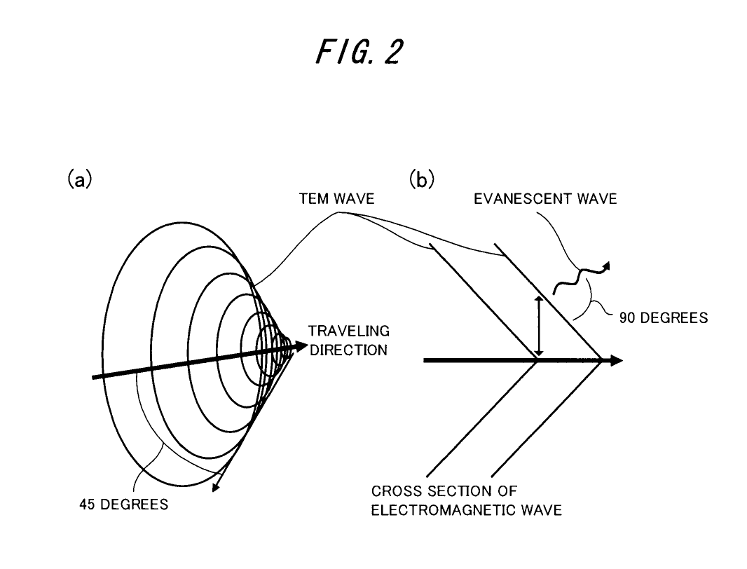

Next, the generation principle of the TEM waves and the evanescent waves is explained with reference to FIG. 2.

Because a magnetic wave progresses in the traveling direction of the signal and in the direction perpendicular to the traveling direction at the same time at light speed, the TEM wave is generated and progresses in a cone shape (circular cone) having a solid angle of 45 degrees as shown in FIG. 2 (a). Furthermore, because the TEM wave is generated continuously from the propagation path of the signal, succeeding waves of the TEM wave are also generated. Because the propagation path of the signal is the core wires 11 in the present embodiment, the TEM wave is generated from the core wires 11.

As shown in FIG. 2 (b), the evanescent wave is generated due to interference caused by the phase shift between the TEM wave and the succeeding waves of the TEM wave. The evanescent wave is generated in the direction orthogonal to the TEM wave. That is, the evanescent wave is emitted into the air at a solid angle of 45 degrees with respect to the traveling direction of the signal. The evanescent wave is generated one after another in the traveling process of the TEM wave, so that the cumulative energy of the evanescent wave cannot be disregarded compared to the attenuation of the signal during transmission. Moreover, the evanescent wave is amplified by the coupling of the core wires 11 being weakened.

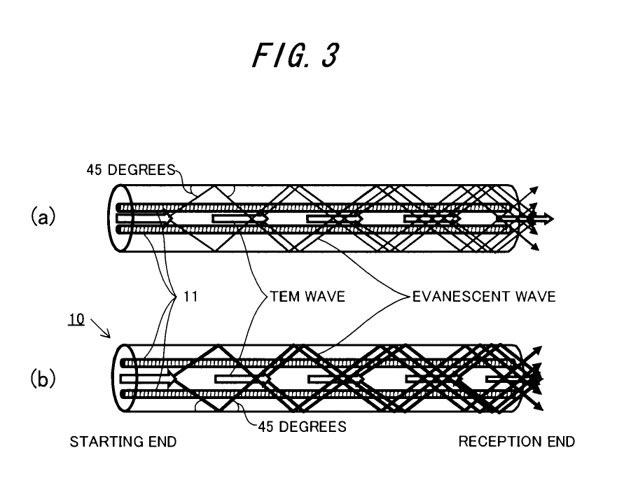

Next, the traveling process of a TEM wave and an evanescent wave in a normal twisted pair cable (for example, a copper wire LAN cable of 0.5 mmφ in category 6) and that in a twisted pair cable 10 in the present embodiment that are the transmission path are shown in FIG. 3. The core wires 11 are shown simply as parallel lines in FIG. 3. First, a mode (state) in which a transmission wave (TEM waves) progresses is explained.

In an ideal pair transmission line, the surrounding of which is filled with air, the permittivity in the surrounding of the pair transmission line becomes homogeneous. Therefore, the generated magnetic field is formed in a right-angled direction with respect to the traveling direction of the transmission wave. In this case, because the expansion of the magnetic field does not collapse, the transmission wave progresses at light speed. This state is referred to as a TEM mode transmission.

Meanwhile, in the case that an insulation material having a relative permittivity of 1 or more is sandwiched between the pair transmission lines, the expansion of the magnetic field collapses. Therefore, a delay wave is generated due to the progression of the transmission wave being delayed compared to in air. This state is referred to as a pseudo TEM mode transmission. The TEM wave attenuates greatly in the pseudo TEM mode transmission.

The TEM wave progresses along the core wires 11 as shown in FIGS. 3 (a) and (b). On the other hand, the evanescent wave that is emitted in the air at a solid angle of 45 degrees with respect to the traveling direction of the TEM wave progresses while repeating a 45 degree reflection due to the shield effect.

The characteristic impedance of the normal twisted pair cable is 100 Ωor less, and the coupling between the core wires 11 becomes strong. Therefore, the evanescent wave is weakened as shown in FIG. 3 (a). Additionally, because a normal twisted pair cable does not have the second coating material 13, it has a pseudo TEM mode transmission. In the case of pseudo TEM mode transmission, the phases of the TEM wave and the evanescent wave shift.

On the other hand, the characteristic impedance of the twisted pair cable 10 of the present embodiment is 135 Ωor more, and the coupling between the core wires 11 is weakened. Therefore, the evanescent wave is strengthened as shown in FIG. 3 (b). Furthermore, because the twisted pair cable 10 has the second coating material 13, it becomes a TEM mode transmission. In TEM mode transmission, the phases match by making the effective lengths of the TEM wave and the evanescent wave to be the same.

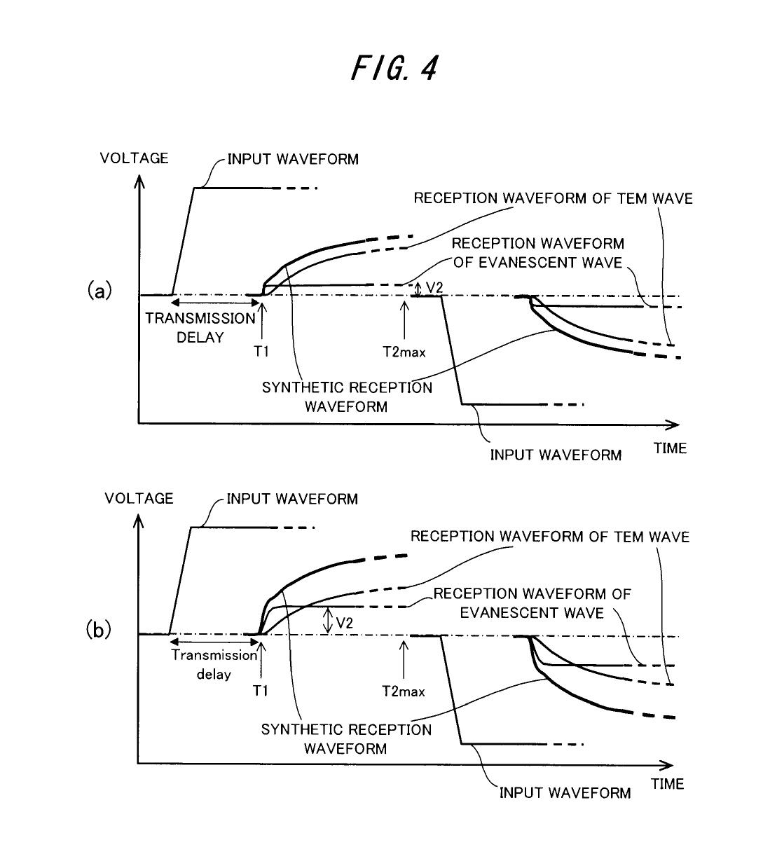

Next, the relationship of an input wave (an input signal) and a reception wave (a reception signal) in the transmission path is explained with reference to FIG. 4.

First, the input wave (the input signal) is supplied into the transmission path from a starting end, and with this, the TEM wave and the evanescent wave are generated. Then, after a specific time that is necessary for propagation of the waveform has elapsed, the TEM wave and the evanescent wave are observed at a reception end as the reception wave (the reception signal).

Because the TEM wave attenuates in the transmission path, the rise of the reception waveform becomes gradual. On the other hand, the waveform at the reception end changes depending on whether the phases of the evanescent wave and the TEM wave match or not. The time when the TEM wave reaches the reception end is assumed to be T1, the time when the evanescent wave that is generated at the starting end of the transmission line and that reaches the reception end latest is assumed to be T2max, and the voltage of the evanescent wave at the reception end is assumed to be V2. The cumulative voltage of the evanescent wave becomes V2/(T2max−T1). Therefore, when T2max becomes equal to or later than the timing of the rise of the next input waveform (the next input signal), the evanescent wave becomes a source of noise. Because a synthetic wave is produced by synthesizing the TEM wave and the evanescent wave, the attenuation of the synthetic wave is also reduced in the case that the attenuation of the evanescent wave is reduced.

The reception waveform of the evanescent wave that is generated in the normal twisted pair cable is not accumulated (superimposed) because there is no shield effect as shown in FIG. 4 (a), and it is observed as a low rectangular wave at the reception end. Because of this, the synthetic waveform of the TEM wave and the evanescent wave also becomes an attenuated waveform.

On the other hand, the attenuation of the evanescent wave that is generated in the twisted pair cable 10 of the present embodiment is smaller than that of the normal twisted pair cable due to the shield effect of the shield material 14, etc. and due to the phase matching with the TEM wave as shown in FIG. 4 (b). That is, the reception waveform of the evanescent wave is integrated in the traveling process of the transmission path and the reception waveform of the evanescent wave rises with very little attenuation. Because of this, the attenuation of the synthetic wave is also small.

A method of making the effective lengths of the TEM wave and the evanescent wave the same (matching the phases) is explained below by showing a specific example.

A formula showing the relationship between the effective length L and the line length Lₒ is shown in Formula (I) below.

L=L₀(1+(1/D2)×π×D3) (1)

Here, the unit of length is m (meter).

In the normal twisted pair cable, the line length (the cable length) Lₒ is set to be 100 m, the diameter D1 of the core wires is set to be 0.5 mm, the pitch D2 of the core wires is set to be 8.25 mm to 12.85 mm, and the spacing D3 of the core wires is set to be 1 mm. The effective length L of the TEM wave becomes 124.4 m to 138 m according to Formula (I). In addition, the effective length of the evanescent wave becomes 141.4 m (=100 m×√2) because the multiple reflections of 45 degrees of the evanescent wave is repeated as shown in FIG. 3 (a). Therefore, the phases differ in the normal twisted pair cable because the effective lengths of the TEM wave and the evanescent wave differ.

Furthermore, in the case that the relative permittivity of the insulation material is made to be 2.2, the transmission speed becomes 2.0×10⁸ m/s (=3.0×10⁸/√2.2). Therefore, the transmission time T1 of the TEM wave from the sending end to the reception end becomes 622 ns to 690 ns. The transmission time T2 of the evanescent wave becomes T1 to 707 ns. Therefore, the minimum difference of the transmission times of the TEM wave and the evanescent wave becomes 17 ns. That is, when transmitting a gigahertz band high frequency signal, because skew within on the order of 100 ps becomes a problem, the evanescent wave becomes a noise in the normal twisted pair cable.

Meanwhile, in the twisted pair cable 10 according to the present embodiment, the line length (the cable length) L₀ is set to be 100 m, the diameter D1 of the core wires 11 is set to be 0.3 mm, the pitch D2 of the core wires 11 is set to be 10. 3 mm, and the spacing D3 of the core wires 11 is set to be 1.36 mm. Therefore, the effective length L of the TEM wave in the twisted pair cable 10 becomes 141.4 m (=L₀×√2) according to Formula (1). Furthermore, the effective length of the evanescent wave in the twisted pair cable 10 becomes 141.4 m because the multiple reflections of 45 degrees of the evanescent wave are performed repeatedly as shown in FIG. 3 (b). Therefore, the phases match in the twisted pair cable 10 according to the present embodiment because the effective lengths of the TEM wave and the evanescent wave match. Furthermore, because the effective lengths of the TEM wave and the evanescent wave match, the transmission times also match. Therefore, the evanescent wave does not become a noise in the twisted pair cable 10 of the present embodiment.

Moreover, in the case of transmitting a 1 GHz signal, 1 clock cycle is 1 ns. Because of this, there is a necessity to make the pitch D2 of the core wires be 10.3 mm±0.4 mm in the twisted pair cable 10 of a 100 m line. Furthermore, there is a necessity to make D2 be 10.3 mm±0.2 mm in a line of 200 m length.

As explained above, the attenuation of the evanescent wave is prevented by the shield effect, and the attenuation of the transmission is reduced and a gigahertz band high frequency signal can be transmitted by matching the phases of the TEM wave and the evanescent wave.

The present invention is not limited to the above-described embodiment, and various transformations and applications are possible.

For example, when the twisted pair cable 10 can be formed to have the characteristic impedance of about 200Ω, the diameter D1 of the core wire 11, etc. may be arbitrarily changed. In addition, the characteristic impedance can be made to be 200 Ωor more.

Furthermore, a shock absorbing material for relieving a shock from an external force may be provided inside or outside of the exterior material 15.

It is also possible to use a cable provided with two or more core wires 11 (copper wires) by twisting a plurality of the twisted pair cables 10.

The present application is based on Japanese Patent Application No. 2008-20869 filed on Jan. 31, 2008. The present description includes the description, the claims, and the entire figures of this application all together as a reference

1. A wire that transmits a gigahertz band signal comprising:
a pair of core wires that are twisted with each other;
a pair of first insulation coating materials that coat each of the core wires;
a second insulation coating material that coats the pair of first insulation coating materials; and
a shield material that coats the second insulation coating material and that shields evanescent waves emitted from the pair of core wires, wherein
the pair of core wires have a twisting pitch, a diameter, and a spacing so that the wire has a characteristic impedance of 100 to 200Ω and the phases of the TEM (Transverse Electro-Magnetic) wave and the evanescent wave that are emitted from the pair of core wires are matched.

2. The wire according to claim 1, wherein
the twisting pitch of the core wires is set so that the effective length of the TEM wave becomes the square root of twice a line length of the pair of core wires.

3. The wire according to claim 1, wherein
the twisting pitch of the core wires is 10.3 mm.

4. The wire according to claim 1, wherein
the diameter of the core wires is 0.3 mm.

5. The wire according to claim 1, wherein
the spacing of the core wires is 1.36 mm.

6. The wire according to claim 1, wherein
a shock absorbing material is provided on the outside of the shield material to relieve shock from an external force.

7. A composite wire wherein a plurality of the wires according claim 1 is provided.
